(19) United States
(12) Patent Application Publication
(10) Pub. No.: US 2003/0043580 A1
(43) Pub. Date: Mar. 6, 2003

(54) GALLERY LAMP STRUCTURE

(76) Inventor: Min-Hsun Hsu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/940,702

(22) Filed: Aug. 29, 2001

(51) Int. Cl. F21V 21/00

(52) U.S. Cl. 362/249; 362/252; 362/806

(57) ABSTRACT

The present invention provides a gallery lamp structure, wherein a plurality of vertical conducting wires are connectedly hung on a transversal conducting wire through connection seats. The bottom end of each of the vertical conducting wires is connected with a color light bulb set. The vertical conducting wires of different lengths are utilized to let the light bulb sets connected therewith and of different heights form a decorative pattern. The present invention has the characteristics of delicacy and diversification to enhance its decorative effect.

### FIELD OF THE INVENTION

The present invention relates to an improved structure of a decorative lamp series and, more particularly, to a gallery lamp structure having hanging type decorative effect.

### BACKGROUND OF THE INVENTION

In the present society, the level of human lives and the requirement of material enjoyment become higher and higher. Some occasional decorative articles need to be arranged in different festivities. In other words, people have higher and varied requirement of decorative articles in festivities.

In some festivities such as Christmas, decorative lamp series are hung for cerebration confirmedly. However, a conventional lamp series is a parallel line from stem to stern, or is wound around a tree. There is less variation, and the arrangement is disordered. Therefore, the decorative effect is limited so as not meet the requirement of customers. Recently, new lamp series structures have been continually proposed. For instance, icicle lamps and netted lamps have been proposed to increase variation in festivities. However, for either an icicle lamp or a netted lamp, a plurality of light bulbs are uniformly arranged on a netted or straight conducting wire. Although they have surmounted the above limitation, decorative effect thereof is manifested with light bulbs spread over the whole conducting wire. Only icicle and netted decorative effects can be achieved so that the variation is limited.

In consideration of the above problems, the present invention proposes a parti-colored gallery lamp structure.

### SUMMARY OF THE INVENTION

The primary object of the present invention is to provide a varied and delicate gallery lamp structure, wherein variation of hanging type decorative light bulbs of different lengths is utilized to exhibit various kinds of decorative patterns, thereby exploiting the best visual feel and achieving the best decorative effect.

Another object of the present invention is to provide a gallery lamp structure of convenient use.

To achieve the above objects, a gallery lamp structure of the present invention comprises a transversal conducting wire with a plurality of straight vertical conducting wires of different lengths arranged and connectedly hung at the lower edge thereof. Each of the vertical conducting wires is connected to a color light bulb sets. Variation of the hanging type color light bulbs is utilized to form a decorative pattern.

The various objects and advantages of the present invention will be more readily understood from the following detailed description when read in conjunction with the appended drawing, in which:

### BRIEF DESCRIPTION OF THE DRAWINGS

FIG. 1 is a structure diagram of the present invention;

FIG. 2 shows an embodiment of the present invention; and

FIG. 3 shows another embodiment of the present invention.

### DETAILED DESCRIPTION OF THE PREFERRED EMBODIMENTS

The present invention is characterized in that hanging type light bulb sets of different lengths are utilized to form various kinds of decorative patterns to provide a parti-colored assembly of lamp series, hence achieving the best visual and decorative effects.

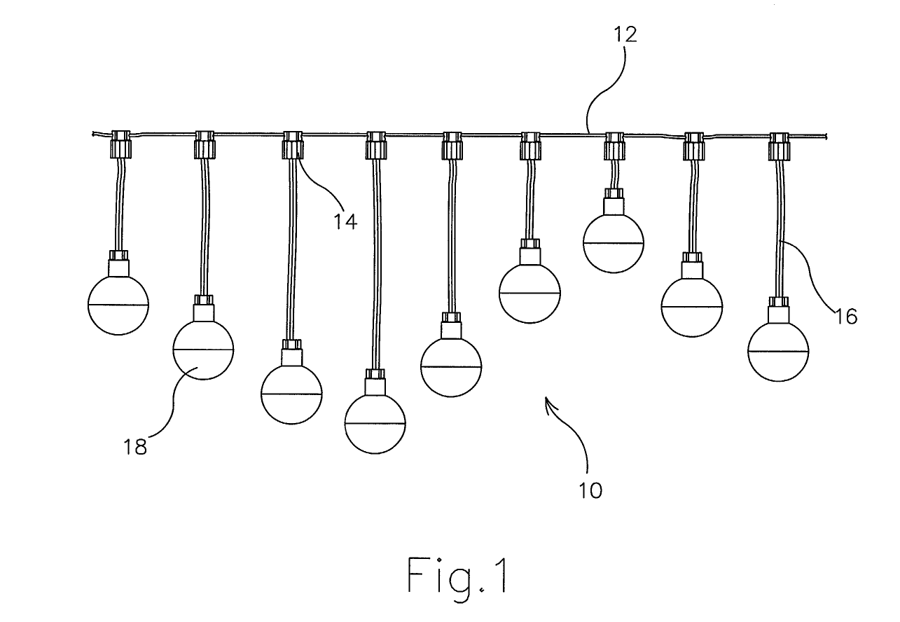

As shown in FIG. 1, a gallery lamp structure 10 comprises a transversal conducting wire 12. A plurality of tidily arranged connection seats 14 are disposed on the transversal conducting wire 12. A plurality of straight vertical conducting wires 16 of different lengths are connectedly hung at the lower edge of the transversal conducting wire 12 through the plurality of connection seats 14. The bottom end of each of the vertical conducting wires 16 is connected with a light bulb set 18. The vertical conducting wires 16 are utilized to let the light bulb sets 18 connected therewith and of different heights form a decorative pattern. The transversal conducting wire 12 and the vertical conducting wires 16 are simultaneously knitted and electrically connected together. A plug (not shown) is connected to one side of the transversal conducting wire 12 of the gallery lamp structure 10 to be plugged into a socket, thereby providing the required electricity for the whole lamp series so that the light bulb sets 18 on the gallery lamp structure 10 can successfully emit light.

The light bulb sets 18 on the gallery lamp structure 10 are color light bulb sets so that the light bulb sets 18 can show a simple pattern with the same color, or they can show various kinds of multi-color patterns with various kinds of different colors.

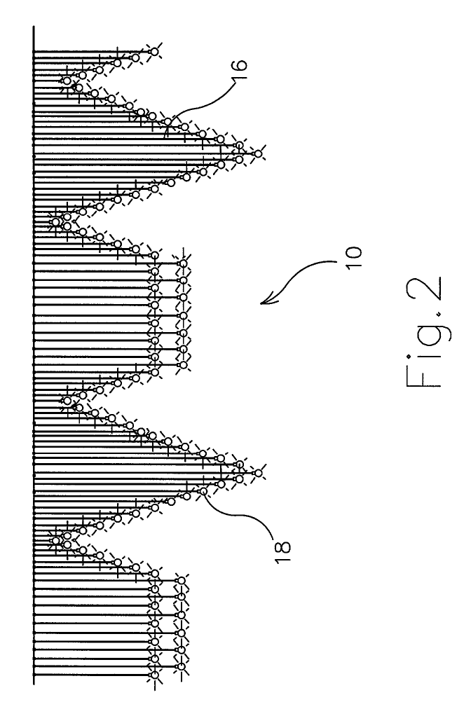

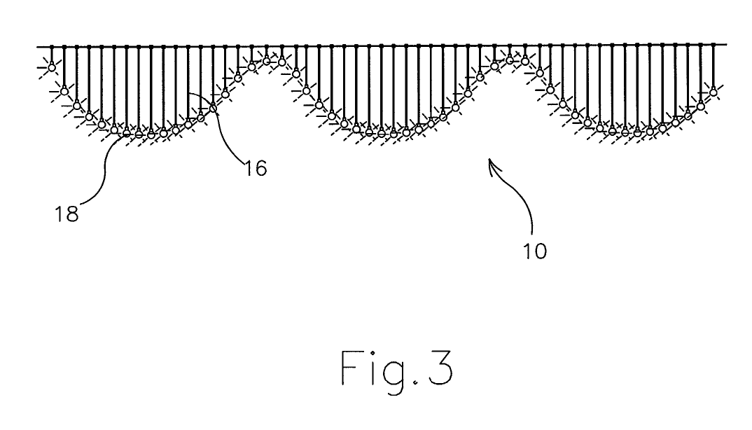

The present invention makes use of hanging type light bulb sets to design different patterns. As shown in FIG. 2, the gallery lamp structure 10 uses the ordered and varied vertical conducting wires 16 and the light bulb sets 18 to form a delicate decorative pattern. As shown in FIG. 3, the gallery lamp structure 10 uses the vertical conducting wires 16 of graded lengths and the light bulb sets 18 to form a wavy decorative pattern, hence showing a style totally different from that of the embodiment shown in FIG. 2.

To sum up, the present invention provides a varied and delicate gallery lamp structure, wherein hanging type decorative light bulbs of different lengths are utilized to exhibit various kinds of decorative patterns, thereby achieving the best visual feel and achieving the best decorative effect. Moreover, when the gallery lamp structure of the present invention is used to show its characteristic decorative effect, it is only necessary to pull straight and fix the transversal conducting wire. Very convenient use can thus be achieved.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A gallery lamp structure comprising a transversal conducting wire with a plurality of vertical conducting wires connectedly hung thereon, each of said vertical conducting wires being connected with a light bulb set;
whereby said light bulb sets can be hung below said transversal conducting wire by using said vertical conducting wires of different lengths to form a decorative pattern.

2. The gallery lamp structure as claimed in claim 1, wherein said light bulb sets are color light bulb sets.

3. The gallery lamp structure as claimed in claim 1, wherein each of said vertical conducting wires is connected to said transversal conducting wire through a connection seat.
